(19) United States
(12) Patent Application Publication
(10) Pub. No.: US 2014/0022047 A1
(43) Pub. Date: Jan. 23, 2014

(54) ELECTRIC POWER FUSE

(71) Applicants: Akira Ando, Urayasu-City (JP); Shinichi Kobayashi, Saitama-Shi (JP)

(72) Inventors: Akira Ando, Urayasu-City (JP); Shinichi Kobayashi, Saitama-Shi (JP)

(73) Assignees: National University Corporation Saitama University, Saitama-shi, (JP); Soshin Electric Co., Ltd., Saku-City (JP)

(21) Appl. No.: 14/009,679

(22) PCT Filed: Apr. 20, 2012
(86) PCT No.: PCT/JP2012/060660

§ 371 Date: Oct. 3, 2013

(30) Foreign Application Priority Data
Apr. 22, 2011 (JP) 2011-095733

(51) Int. Cl. H01H 85/48

(52) U.S. Cl. CPC H01H 85/48
USPC 337/297

(57) ABSTRACT

This electric power fuse has a fuse element that is formed continuously and integrally by a plurality of heat dissipating parts formed from a conductive film by the conductive film being formed on a ceramic substrate and a plurality of isolating parts. The conductive film is constituted of printed layers formed by printing one or more times on the surface of the ceramic substrate, and the number of laminations of printed layers formed in the heat dissipating parts is greater than or equal to the number of laminations of the printed layers constituting the isolating parts.

### TECHNICAL FIELD

The present invention relates to an electric power fuse, which has an electrically conductive film disposed on a substrate, and includes heat radiation zones and current-interruption grids that are provided integrally in succession.

### BACKGROUND ART

Heretofore, a main requirement for electric power fuses for protecting semiconductor switching devices such as GTO (Gate Turn Off) thyristors and IGBTs (Insulated Gate Bipolar Transistors) is to have a quick cutoff performance.

Such electric power fuses have a fuse element embedded in an arc-extinguishing material, which is housed in a fuse tube. Known types of fuse elements include fuse elements produced by a pressing process and fuse elements produced by an etching process (see Japanese Laid-Open Patent Publication No. 2006-073331 and Japanese Laid-Open Patent Publication No. 2009-193723). A pressed fuse element includes an array of several narrow cutoff canals, each having a small cross-sectional area, which are punched out of a ribbon of metal, e.g., silver (Ag), by a pressing die. An etched fuse element has an electrically conductive thin film of copper, silver, or the like disposed on the upper surface of a ceramic substrate. An electrically conductive thin film is etched and patterned into the array of several narrow cutoff canals each having a small cross-sectional area. The pressed fuse element includes an electrically conductive thin film that is limited in both thickness and line width to 150 μm, which poses limitations on efforts to lower the I²t value and to reduce the size of the electric power fuse. On the other hand, the electrically conductive thin film that is made up of the etched fuse element can have a smaller thickness and line width, thus allowing the etched fuse element to have a lower I²t value and a smaller size than the pressed fuse element. However, the etched fuse element leaves much to be improved in relation to cost and manufacturing variations, which tend to occur when the etched fuse element is mass-produced. The I²t value refers to a representative value indicative of a cutoff performance, which is calculated by integrating the square of a cutoff current I (I²dt) over a cutoff time from 0 to t (t: total cutoff time).

### SUMMARY OF THE INVENTION

If a fuse element is fabricated by etching, a liquid etchant, which exhibits a property to corrode and dissolve a target metal, is applied in order to remove portions of an electrically conductive thin film disposed on a ceramic substrate, thereby producing a desired conductive pattern. The conductive pattern required on the fuse element is a pattern having a high aspect ratio, such that heat radiation zones have a thickness of about 100 μm, and current-interruption grids have a width ranging from 65 to 100 μm and a thickness of about 25 μm.

Fabrication of a fuse element by etching suffers from the following problems:

(a) If the electrically conductive thin film is etched deeply, then the electrically conductive film is susceptible to corrosion beneath the etching mask, creating undercuts. Therefore, it is difficult to micro-fabricate the electrically conductive thin film with high precision.

(b) Since the etching rate changes depending on the temperature of the etchant and the stirring speed at which the etchant is stirred, repeatability of the etching process, i.e., repeatability of the conductive pattern, is poor.

As a result, the conductive pattern of the current-interruption grids varies at different positions on the substrate, or varies among ceramic substrates.

Consequently, the amount of pattern conductor in each of the current-interruption grids and the overall resistance value of the fuse element are likely to vary, leading to variations in the I²t value and variations in the rated current.

Minimizing variations between the current-interruption grids and variations between fuse elements poses limitations on efforts to reduce the width of the current-interruption grids. Therefore, the I²t value, the cost, and the size of the electric power fuse cannot be reduced sufficiently.

The present invention has been made in view of the above problems. It is an object of the present invention to provide an electric power fuse, which makes it possible to reduce the I²t value, the cost, and the size of the electric power fuse, while at the same time minimizing variations between the current-interruption grids and variations between fuse elements.

[1] An electric power fuse according to the present invention includes a fuse element having an electrically conductive film, which is disposed on a substrate and includes a plurality of heat radiation zones and a plurality of current-interruption grids that are provided integrally in succession, wherein the electrically conductive film comprises a printed layer disposed on a surface of the substrate by one or more printing processes, and a number of laminae of the printed layer of the heat radiation zones is equal to or greater than a number of laminae of the printed layer of the current-interruption grids.

With the above arrangement, variations in the film thickness of the narrow cutoff canals between the current-interruption grids and variations between fuse elements can be minimized, thereby minimizing variations in the I²t value. Since the heat radiation zones and the current-interruption grids are printed, the heat radiation zones and the current-interruption grids can be formed separately from each other, so that the thickness of the narrow cutoff canals of the current-interruption grids can be controlled as desired independently of the thickness of the heat radiation zones. By controlling the thickness of the narrow cutoff canals in this manner, a reduction in the I²t value can be achieved. Consequently, the electric power fuse can be reduced in cost and size.

[2] According to the present invention, each of the current-interruption grids may have a plurality of narrow cutoff canals arrayed in parallel, and the current-interruption grids may be arranged in series, thereby providing the fuse element.

[3] The current-interruption grids, each having the narrow cutoff canals arrayed in parallel, and which are shaped identical to each other, may serve as first current-interruption grids. The first current-interruption grids may be arranged in series, thereby making up a first fuse section, and the first fuse section and a second fuse section, which has current vs. fusing time characteristics that differ from the first fuse section, may be connected in succession on the same substrate. An electric power fuse constructed in this manner exhibits characteristics in which the gradient of time with respect to current in a higher current range is greater than the gradient of time with respect to current in a lower current range.

[4] The second fuse section may comprise a plurality of second current-interruption grids arranged in series, and the second current-interruption grids may differ from the first current-interruption grids of the first fuse section in relation to at least one of a shape of the narrow cutoff canals, a width of the narrow cutoff canals, and the number of laminae of the printed layer.

[5] A metal material of the printed layer of the first current-interruption grids of the first fuse section and a metal material of the printed layer of the second current-interruption grids of the second fuse section may be different from each other.

[6] In the electric power fuse of the present invention, an antioxidizing film may be disposed on surfaces of at least the current-interruption grids. The antioxidizing film is effective to prevent at least the current-interruption grids from becoming oxidized, thereby enabling the fuse element to operate reliably over a long period of time.

[7] According to the present invention, an arc-extinguishing material paste may be printed on at least the current-interruption grids. In this manner, the internal space that houses the arc-extinguishing material therein is reduced. The printed arc-extinguishing material paste is effective to significantly reduce the size of the electric power fuse.

As described above, the electric power fuse according to the present invention offers the following advantages:

(1) Variations in the film thickness of the narrow cutoff canals between the current-interruption grids and variations between fuse elements can be minimized, thereby minimizing variations in the I²t value.

(2) Since the heat radiation zones and the current-interruption grids are printed, the heat radiation zones and the current-interruption grids can be formed separately from each other, so that the thickness of the narrow cutoff canals of the current-interruption grids can be controlled as desired independently of the thickness of the heat radiation zones. By controlling the thickness of the narrow cutoff canals in this manner, a reduction in the I²t value can be achieved.

(3) On account of advantages (1) and (2), the electric power fuse can be reduced in cost and size.

### BRIEF DESCRIPTION OF DRAWINGS

FIG. 1 is a cross-sectional view of an electric power fuse according to an embodiment of the present invention;

FIG. 2 is a plan view, partially omitted from illustration, showing by way of example a conductive pattern of a fuse element of the electric power fuse;

FIG. 3 is a cross-sectional view, partially omitted from illustration, of the fuse element;

FIG. 4A is a cross-sectional view, partially omitted from illustration, showing an arc-extinguishing material, which is made into a paste with a solvent (hereinafter referred to as an “arc-extinguishing material paste”), and is printed on current-interruption grids;

FIG. 4B is a cross-sectional view, partially omitted from illustration, showing the arc-extinguishing material paste printed on current-interruption grids and heat radiation zones;

FIG. 5 is a plan view showing a general structure of a fuse element according to first (first fuse element) through sixth (sixth fuse element) modifications;

FIG. 6A is a plan view, partially omitted from illustration, showing a conductive pattern in a first fuse section of the first fuse element;

FIG. 6B is a plan view, partially omitted from illustration, showing a conductive pattern in a second fuse section of the first fuse element;

FIG. 7A is a cross-sectional view, partially omitted from illustration, showing a first fuse section of the second fuse element;

FIG. 7B is a cross-sectional view, partially omitted from illustration, showing a second fuse section of the second fuse element;

FIG. 8A is a plan view, partially omitted from illustration, showing a conductive pattern in a first fuse section of the third fuse element;

FIG. 8B is a plan view, partially omitted from illustration, showing a conductive pattern in a second fuse section of the third fuse element;

FIG. 9A is a plan view, partially omitted from illustration, showing a conductive pattern in a first fuse section of the fourth fuse element;

FIG. 9B is a plan view, partially omitted from illustration, showing a conductive pattern in a second fuse section of the fourth fuse element;

FIG. 10A is a plan view, partially omitted from illustration, showing a conductive pattern in a first fuse section of the fifth fuse element;

FIG. 10B is a plan view, partially omitted from illustration, showing a conductive pattern in a second fuse section of the fifth fuse element;

FIG. 11A is a cross-sectional view, partially omitted from illustration, showing a first fuse section of the sixth fuse element;

FIG. 11B is a cross-sectional view, partially omitted from illustration, showing a second fuse section of the sixth fuse element;

FIG. 12 is a graph showing by way of example fusing characteristics of an electric power fuse that incorporates the sixth fuse element; and

FIG. 13 is a graph showing operating characteristics (rated current vs. operating I²t value characteristics) of Inventive Example 1 (see FIGS. 2 and 3) and Comparative Examples 1 and 2.

### DESCRIPTION OF EMBODIMENTS

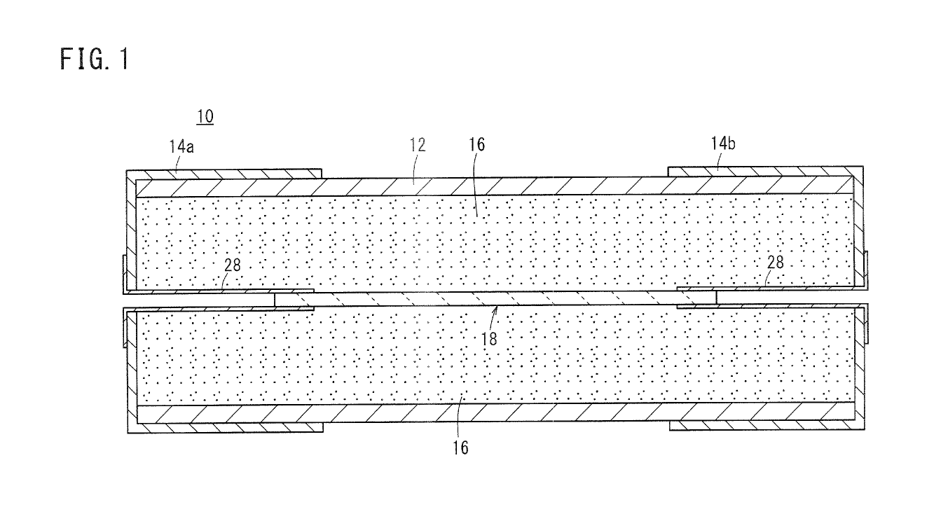

Electric power fuses according to embodiments of the present invention will be described below with reference to FIGS. 1 through 13. In the following description, the terms “from” and “to” in numerical ranges should be interpreted as inclusive of numerical values that follow these terms as lower and upper limit values of the numerical ranges.

As shown in FIG. 1, an electric power fuse 10 according to an embodiment of the present invention includes a casing 12 made of resin and having a round tubular shape, a rectangular tubular shape, or the like, a first terminal 14a and a second terminal 14b made of metal and mounted respectively on both sides of the casing 12, and an arc-extinguishing material 16 such as silica sand or the like and a fuse element 18, which are housed in the casing 12.

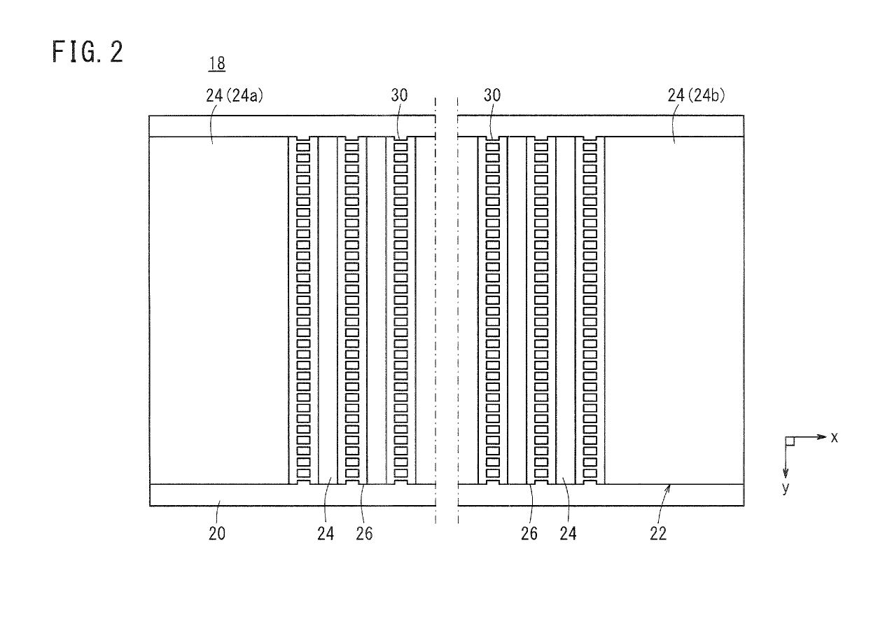

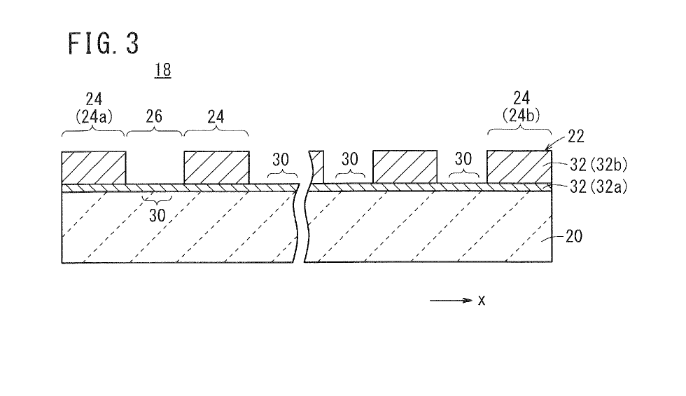

As shown in FIGS. 2 and 3, the fuse element 18 includes a ceramic substrate 20 made of alumina or the like having a thickness of 1 mm, for example, and an electrically conductive film 22 disposed on the ceramic substrate 20. More specifically, the fuse element 18 comprises the electrically conductive film 22 disposed on the ceramic substrate 20, and which includes a plurality of heat radiation zones 24 and a plurality of current-interruption grids 26 that are provided integrally in succession. Among the heat radiation zones 24, the heat radiation zones 24 that are positioned on both sides are electrically connected to corresponding terminals (the first terminal 14a and the second terminal 14b shown in FIG. 1) by metal connecting plates 28 (see FIG. 1). The heat radiation zones 24 that are positioned on both sides may also be referred to as a first terminal connector 24a and a second terminal connector 24b. A direction from the first terminal connector 24a to the second terminal connector 24b (or a direction from the second terminal connector 24b to the first terminal connector 24a) is referred to as a lengthwise direction (x direction), whereas a direction perpendicular to the lengthwise direction on the electrically conductive film 22 is referred to as a widthwise direction (y direction).

As shown in FIG. 2, each of the current-interruption grids 26 has a plurality of narrow cutoff canals 30 arrayed in parallel along the y direction. The current-interruption grids 26 also are arranged in series along the x direction, thereby providing the fuse element 18. In FIG. 2, each of the current-interruption grids 26 has thirty-two narrow cutoff canals 30, which are arrayed in parallel along the y direction, whereas the current-interruption grids 26 are arranged in series along the x direction, with each heat radiation zone 24 being sandwiched between two adjacent current-interruption grids 26. The narrow cutoff canals 30, particularly the side walls thereof as viewed in plan, are substantially straight in shape.

As shown in FIG. 2, the electrically conductive film 22 comprises a printed layer 32, which is arranged on the surface of the ceramic substrate 20 by one or more printing processes. The number of laminae of the printed layer 32 of the heat radiation zones 24 is equal to or greater than the number of laminae of the printed layer 32 of the current-interruption grids 26. The printed layer 32 may be fabricated from an ink such as copper paste, silver paste, or the like, for example. In FIG. 2, the number of laminae of the printed layer 32 of the heat radiation zones 24 is 2, whereas the number of laminae of the printed layer 32 of the current-interruption grids 26 is 1. The numbers of the laminae may be in any combination, insofar as the number of laminae of the printed layer 32 of the heat radiation zones 24 is equal to or greater than the number of laminae of the printed layer 32 of the current-interruption grids 26. A printed layer 32a, which is provided as the first lamina, and a printed layer 32b, which is provided as the second lamina, may have the same thickness or different thicknesses. In FIG. 3, the printed layer 32a, which serves as the first lamina, is deposited to a thickness ranging from 20 to 30 μm, for example, on the ceramic substrate 20 by a first screen printing process, whereas the printed layer 32b, which serves as the second lamina, is deposited to a thickness ranging from 75 to 100 μm, for example, on the printed layer 32a by a second screen printing process. When the printed layer 32a that serves as the first lamina is printed, the narrow cutoff canals 30 of the current-interruption grids 26 are produced simultaneously therewith. According to a conventional etching process, a plated layer is deposited to a thickness corresponding to the thickness of the current-interruption grids, and then is etched selectively in order to produce the current-interruption grids, after which an additional plated layer is deposited to produce the heat radiation zones while the current-interruption grids are in a masked state. The conventional etching process is complex and poor in accuracy, since different processes need to be repeated including the plating process and the etching process.

According to the present embodiment, since the electrically conductive film 22, which includes the heat radiation zones 24 and the current-interruption grids 26, is formed on the ceramic substrate 20 by a screen printing process, the electrically conductive film 22 can be produced more easily than by the etching process described above. Further, since upper portions of the narrow cutoff canals 30 and the heat radiation zones 24 are not subject to corrosion, any variations in the pattern shape (thickness, etc.) between the current-interruption grids 26 or between the heat radiation zones 24, and any variations in the pattern shape (thickness, etc.) between fuse elements 18 are minimized when the patterned electrically conductive film 22 is formed. Accordingly, a conductive pattern made up of the electrically conductive film 22 can be fabricated with high precision.

More specifically, variations in the film thickness of the narrow cutoff canals 30 between the current-interruption grids 26 and variations between fuse elements 18 can be minimized, thereby minimizing variations in the I²t value. Moreover, since the heat radiation zones 24 and the current-interruption grids 26 are printed, they can be formed separately from each other, so that the thickness of the narrow cutoff canals 30 of the current-interruption grids 26 can be controlled as desired independently of the thickness of the heat radiation zones 24. By controlling the thickness of the narrow cutoff canals 30 in this manner, a reduction in the I²t value can be achieved. Consequently, the electric power fuse 10 can be reduced in cost and size.

According to a preferred feature of the fuse element 18, an antioxidizing film of CuO or the like is disposed on surfaces of at least the current-interruption grids 26. Preferably, a CuO paste or the like is deposited only on upper surfaces of the current-interruption grids 26, for example, by a screen printing process to thereby form an antioxidizing film having a thickness of about several μm. The antioxidizing film, which is printed in this manner, is effective to prevent at least the current-interruption grids 26 from becoming oxidized, thereby enabling the fuse element 18 to operate reliably over a long period of time.

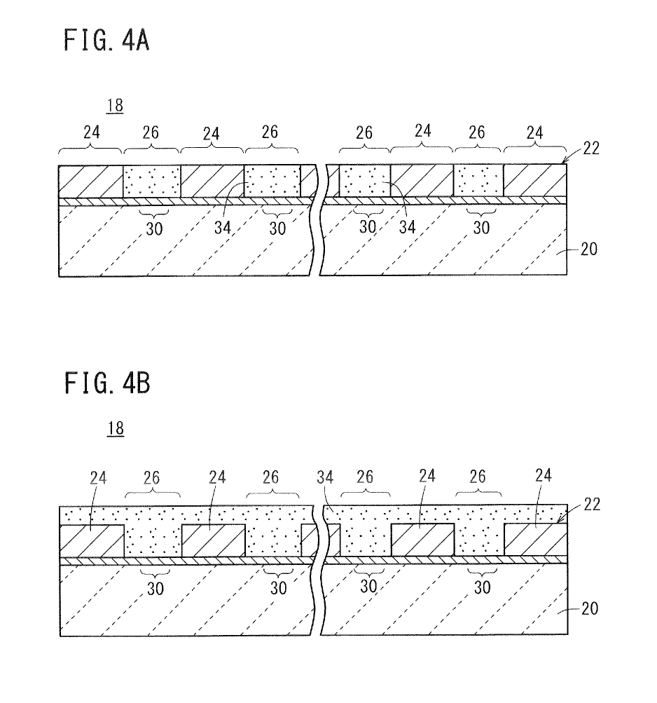

According to another preferred feature of the fuse element 18, the arc-extinguishing material 16 is made into a paste and is printed on the surface of the fuse element 18. More specifically, as shown in FIG. 4A, the arc-extinguishing material 16 is made into a paste (of SiO₂ or the like), i.e., an arc-extinguishing material paste 34, with a solvent, and the arc-extinguishing material paste 34 is printed on the current-interruption grids 26. Alternatively, as shown in FIG. 4B, the arc-extinguishing material paste 34 may be printed respectively on the current-interruption grids 26 and the heat radiation zones 24. Generally, the majority of the internal space of the electric power fuse 10 is filled with the arc-extinguishing material 16. Since the region that actually is required to quench arcs in the electric power fuse 10 merely comprises a region that lies close to surfaces of the current-interruption grids 26, the arc-extinguishing material paste 34 is printed on at least the current-interruption grids 26. In this manner, the internal space in which the arc-extinguishing material 16 is accommodated can be reduced. Further, the printed arc-extinguishing material paste 34 is effective to significantly reduce the size of the electric power fuse 10.

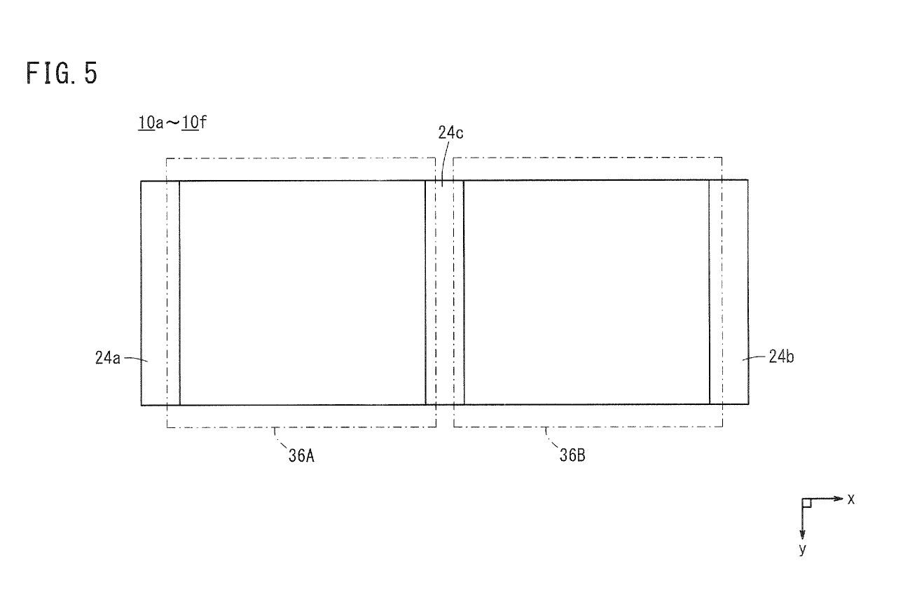

Various modifications of the fuse element 18 will be described below with reference to FIGS. 5 through 11B.

As shown in FIG. 5, a fuse element according to a first modification (hereinafter referred to as a “first fuse element 18a”) includes a first fuse section 36A and a second fuse section 36B, which are disposed between the first terminal connector 24a and the second terminal connector 24b, and are connected in succession (in series) with a central heat radiation zone 24c being interposed therebetween.

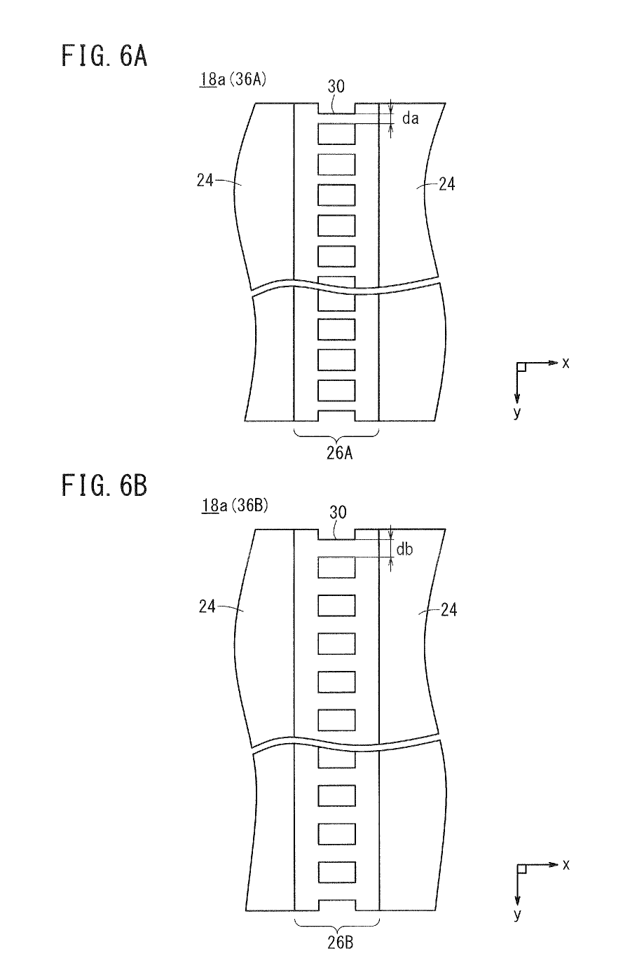

As shown with partial omission in FIG. 6A, the first fuse section 36A includes a plurality of first current-interruption grids 26A, each having thirty-two parallel narrow cutoff canals 30, for example, arranged in series along the x direction. As shown with partial omission in FIG. 6B, the second fuse section 36B includes a plurality of second current-interruption grids 26B, each having thirty-two parallel narrow cutoff canals 30, for example, arranged in series along the x direction. The narrow cutoff canals 30 of the first current-interruption grids 26A have a width (a length in the y direction) da, and the narrow cutoff canals 30 of the second current-interruption grids 26B have a width (a length in the y direction) db, which differs from the width da. More specifically, as shown in FIGS. 6A and 6B, the width db of the narrow cutoff canals 30 of the second current-interruption grids 26B is greater than the width da of the narrow cutoff canals 30 of the first current-interruption grids 26A.

A fuse element according to a second modification (hereinafter referred to as a “second fuse element 18b”) essentially is the same in structure as the first fuse element 18a described above, but differs therefrom as described below.

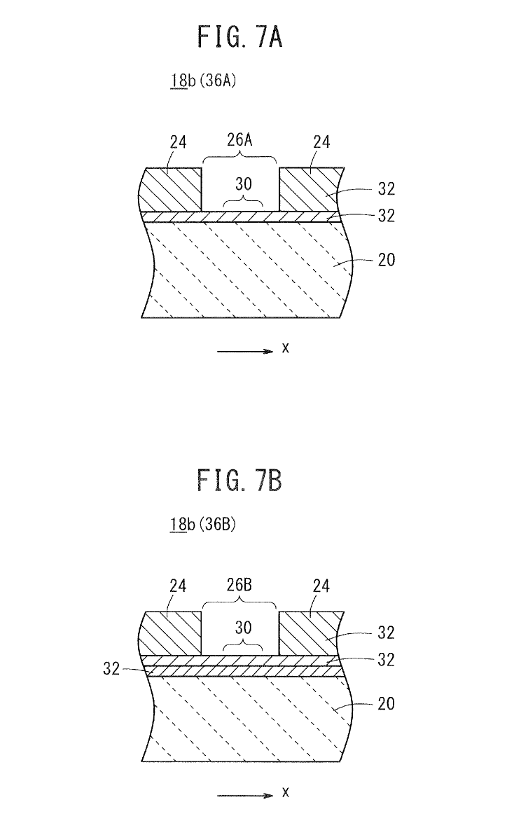

As shown in FIGS. 7A and 7B, the number of laminae of the printed layer 32 of the first current-interruption grids 26A and the number of laminae of the printed layer 32 of the second current-interruption grids 26B differ from each other. In FIGS. 7A and 7B, the number of laminae of the printed layer 32 of the first current-interruption grids 26A is 1, whereas the number of laminae of the printed layer 32 of the second current-interruption grids 26B is 2.

A fuse element according to a third modification (hereinafter referred to as a “third fuse element 18c”) essentially is the same in structure as the first fuse element 18a described above, but differs therefrom as described below.

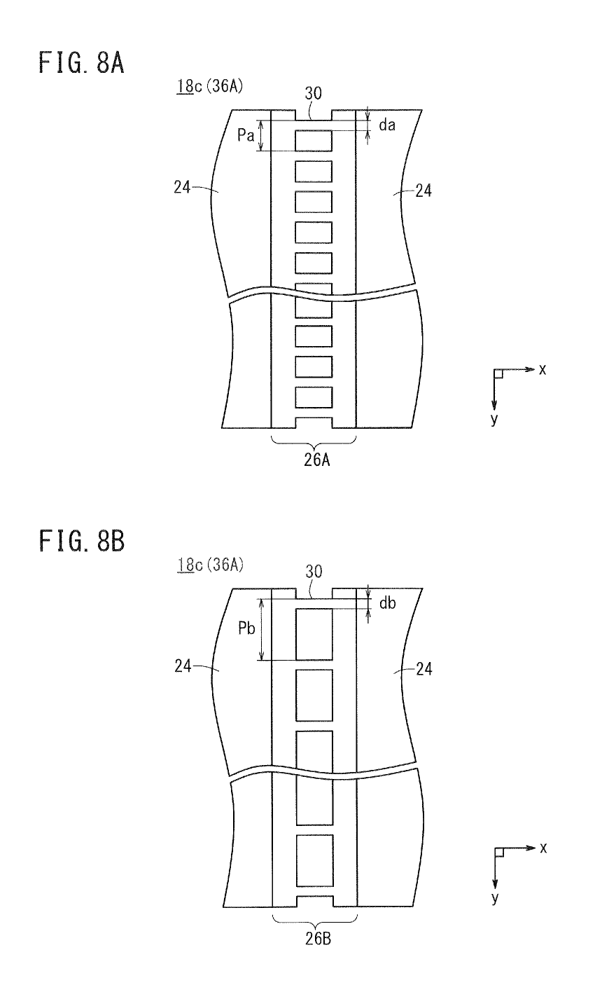

As shown in FIGS. 8A and 8B, the narrow cutoff canals 30 of the first current-interruption grids 26A have a width da and an array pitch Pa, and the narrow cutoff canals 30 of the second current-interruption grids 26B have a width db and an array pitch Pb. The respective widths and array pitches are related as follows:

da=db

Pa<Pb

A fuse element according to a fourth modification (hereinafter referred to as a “fourth fuse element 18d”) essentially is the same in structure as the first fuse element 18a described above, but differs therefrom as described below.

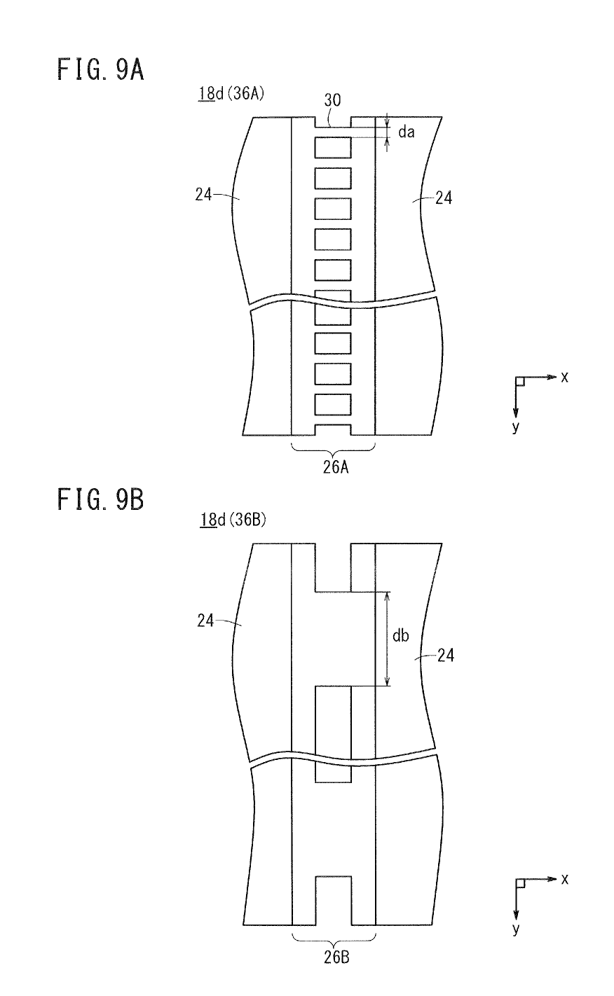

As shown in FIGS. 9A and 9B, the width db and the array pitch of the narrow cutoff canals 30 of the second current-interruption grids 26B are greater than the width da and the array pitch of the narrow cutoff canals 30 of the first current-interruption grids 26A.

A fuse element according to a fifth modification (hereinafter referred to as a “fifth fuse element 18e”) essentially is the same in structure as the first fuse element 18a described above, but differs therefrom as described below.

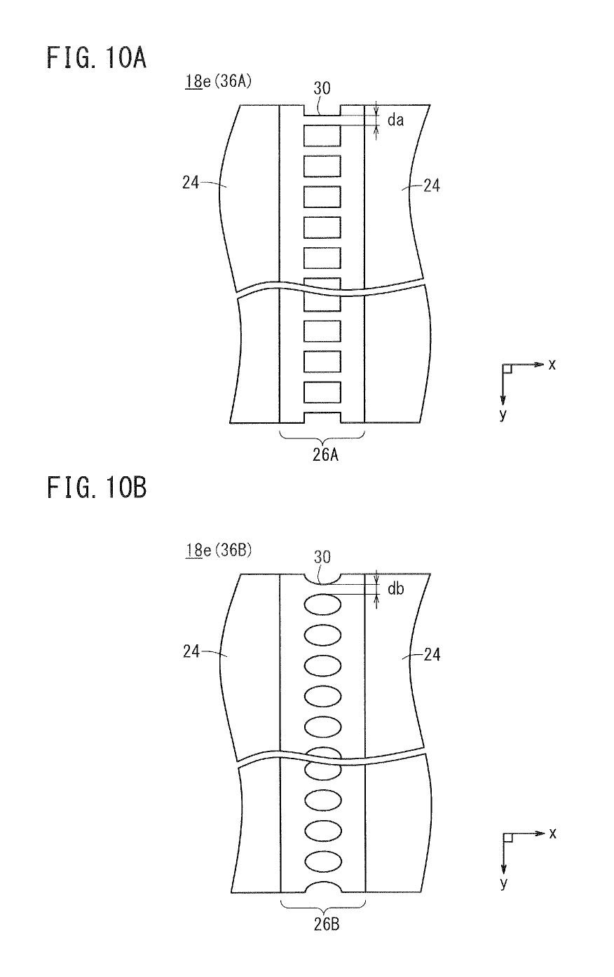

The narrow cutoff canals 30 of the first current-interruption grids 26A and the narrow cutoff canals 30 of the second current-interruption grids 26B differ in shape. In FIGS. 10A and 10B, the side walls of the narrow cutoff canals 30 of the first current-interruption grids 26A are substantially straight in shape as viewed in plan, whereas the side walls of the narrow cutoff canals 30 of the second current-interruption grids 26B are of a curved shape. The width da (the length in the y direction) of the narrow cutoff canals 30 of the first current-interruption grids 26A may be different from or identical to a smallest width db of the narrow cutoff canals 30 of the second current-interruption grids 26B.

A fuse element according to a sixth modification (hereinafter referred to as a “sixth fuse element 18f”) essentially is the same in structure as the first fuse element 18a described above, but differs therefrom as described below.

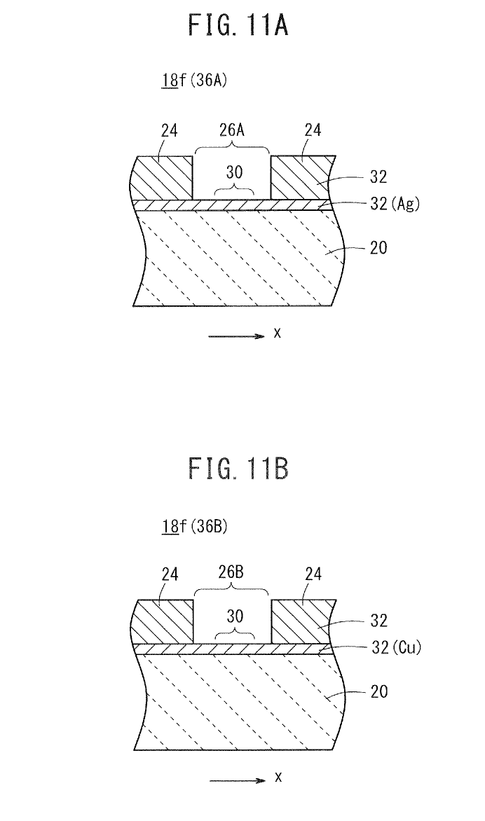

As shown in FIGS. 11A and 11B, the number of laminae of the printed layer 32 of the first current-interruption grids 26A and the number of laminae of the printed layer 32 of the second current-interruption grids 26B are the same as each other. On the other hand, the metal material of the printed layer 32 of the first current-interruption grids 26A differs from the metal material of the printed layer 32 of the second current-interruption grids 26B. For example, the first current-interruption grids 26A have a printed layer 32 made of silver paste, whereas the second current-interruption grids 26B have a printed layer 32 made of copper paste. Insofar as the metal material of the printed layer 32 of the first current-interruption grids 26A and the metal material of the printed layer 32 of the second current-interruption grids 26B differ from each other, metal materials having low melting points, which generally are used as fuses, may be used in combination.

The first current-interruption grids 26A and the second current-interruption grids 26B of the first through sixth fuse elements 18a through 18f may be combined as desired to fabricate a new fuse element.

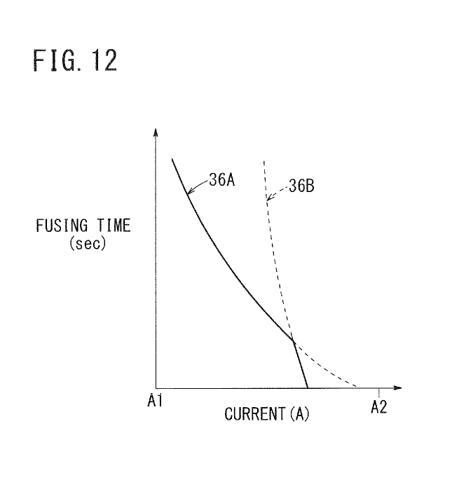

With respect to the first through sixth fuse elements 18a through 18f, the fusing characteristics (current vs. fusing time characteristics) of the first fuse section 36A and the second fuse section 36B may be changed. In particular, as shown in FIG. 12, according to current vs. fusing time characteristics from a first current value A1 to a second current value A2, in the sixth fuse element 18f, the second fuse section 36B exhibits a sharper change in fusing time with respect to current than the first fuse section 36A.

As a consequence, as indicated by the solid line in FIG. 12, the electric power fuse 10 exhibits, as an overall current vs. fusing time characteristic curve of the sixth fuse element 18f, characteristics such that a change in the time with respect to current in a higher current range is sharper than a change in the time with respect to current in a lower current range.

### EXAMPLES

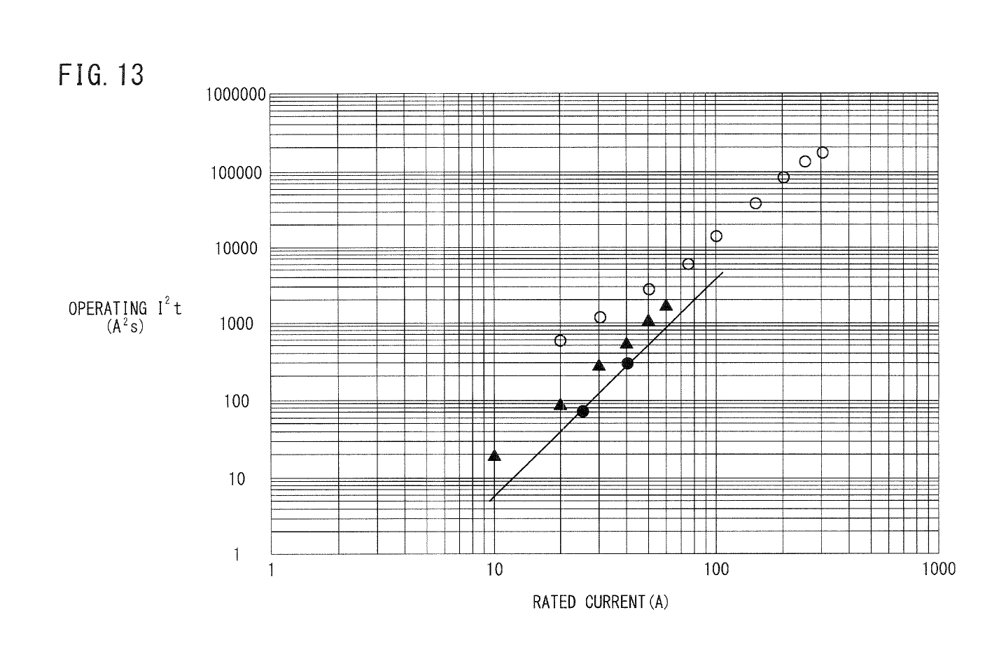

Operating characteristics (rated current vs. operating I²t value characteristics) associated with Comparative Examples 1 and 2 and Inventive Example 1 were confirmed. FIG. 13 shows the operating characteristics (rated current vs. operating I²t value characteristics) of Inventive Example 1 together with those of Comparative Examples 1 and 2. In FIG. 13, the characteristic curve plotted with pertains to Inventive Example 1, the characteristic curve plotted with ▴ pertains to Comparative Example 1, and the characteristic curve plotted with ◯ pertains to Comparative Example 2.

The characteristic curve of Comparative Example 1 shown in FIG. 13 is plotted based on data of a commercially available product, which was etched to produce a pattern equivalent to the pattern shown in FIG. 3 of Japanese Laid-Open Patent Publication No. 2006-073331.

The characteristic curve of Comparative Example 2 shown in FIG. 13 is plotted based on data of a commercially available product, which was fabricated by pressing a silver ribbon.

The characteristic curve of Inventive Example 1 is plotted based on data of an electric power fuse, which is similar in structure to the electric power fuse 10 according to the present embodiment. The fuse element 18 was fabricated in the following manner. First, as shown in FIG. 3, an alumina substrate having a thickness of 1 mm was used as the ceramic substrate 20, and a printed layer 32a (printed layer of copper paste) having a thickness of 25 μm was formed as the first lamina on the alumina substrate by a screen printing process. At this time, the printed layer 32a was printed in the pattern shown in FIG. 2. Thereafter, another printed layer 32b (printed layer of copper paste) having a thickness of 75 μm was formed as the second lamina on the printed layer 32a by a second screen printing process. At this time, the printed layer 32b was printed only in areas that were intended to become the respective heat radiation zones 24.

As can be understood from the results shown in FIG. 13, Inventive Example 1 exhibits better operating characteristics than Comparative Examples 1 and 2. More specifically, the electric power fuse according to Inventive Example 1 is capable of reducing the I²t value, is both low in cost and small in size, and at the same time, is capable of minimizing variations between the current-interruption grids 26 and variations between the fuse elements 18.

The electric power fuse according to the present invention is not limited to the above embodiment, but may incorporate various additional or alternative arrangements without departing from the scope of the invention.

1. An electric power fuse including a fuse element having an electrically conductive film, which is disposed on a substrate and includes a plurality of heat radiation zones and a plurality of current-interruption grids that are provided integrally in succession, wherein:
the electrically conductive film comprises a printed layer disposed on a surface of the substrate by one or more printing processes; and
a number of laminae of the printed layer of the heat radiation zones is equal to or greater than a number of laminae of the printed layer of the current-interruption grids.

2. The electric power fuse according to claim 1, wherein each of the current-interruption grids has a plurality of narrow cutoff canals arrayed in parallel; and
the current-interruption grids are arranged in series, thereby providing the fuse element.

3. The electric power fuse according to claim 2, wherein the current-interruption grids, each having the narrow cutoff canals arrayed in parallel, and which are shaped identical to each other, serve as first current-interruption grids;
the first current-interruption grids are arranged in series, thereby making up a first fuse section; and
the first fuse section and a second fuse section, which has current vs. fusing time characteristics that differ from the first fuse section, are connected in succession on a same substrate.

4. The electric power fuse according to claim 3, wherein the second fuse section comprises a plurality of second current-interruption grids arranged in series, and the second current-interruption grids differ from the first current-interruption grids of the first fuse section in relation to at least one of a shape of the narrow cutoff canals, a width of the narrow cutoff canals, and the number of laminae of the printed layer.

5. The electric power fuse according to claim 3, wherein a metal material of the printed layer of the first current-interruption grids of the first fuse section and a metal material of the printed layer of the second current-interruption grids of the second fuse section are different from each other.

6. The electric power fuse according to claim 1, wherein an antioxidizing film is disposed on surfaces of at least the current-interruption grids.

7. The electric power fuse according to claim 1, wherein an arc-extinguishing material paste is printed on at least the current-interruption grids.
